(19) United States
(12) Patent Application Publication
(10) Pub. No.: US 2015/0096367 A1
(43) Pub. Date: Apr. 9, 2015

(54) Systems and Methods for Measuring Levels of Liquids of Different Densities in Containers

(71) Applicant: Spectra Symbol Corporation, Salt Lake City, UT (US)

(72) Inventors: Daniel Foote Marriott, Salt Lake City, UT (US); William Arthur Weatherholtz, II, West Jordan, UT (US)

(73) Assignee: Spectra Symbol Corporation, Salt Lake City, UT (US)

(21) Appl. No.: 14/048,977

(22) Filed: Oct. 8, 2013

(51) Int. Cl. G01F 23/22; G01F 23/24

(52) U.S. Cl. CPC G01F 23/22; G01F 23/241
USPC 73/313

(57) ABSTRACT

Systems and methods for measuring or determining the level or amount of multiple immiscible liquids of different densities in containers utilize multiple floats, with each float having a density less than the density of the liquid to be measured but greater than the density of the next less dense liquid (or fluid) in the container. In this fashion, the position of each float can be determined and used to determine the levels of the various liquids using a single three-terminal potentiometer. A method includes measuring first and second electrical signals corresponding to first and second locations of actuation of the potentiometer. A system includes a three terminal potentiometer capable of magnetic actuation at two locations, a first float configured to magnetically actuate the potentiometer at a first location, and a second float configured to magnetically actuate the potentiometer at a second location that differs from the first location.

### BACKGROUND OF THE INVENTION

1. Field of the Invention

The present invention relates to measuring levels of liquids in containers, and more particularly to systems and methods for simultaneously measuring levels of multiple immiscible liquids of different densities in the containers.

2. Background and Related Art

It is commonplace to use containers to contain various liquids of a variety of properties. It is also commonplace to desire to know the level of one or more liquids contained by a given container. The level or amount of a liquid contained in a container may be ascertained in a variety of fashions. In some instances, a container or a portion of a container may be made transparent or semi-transparent to permit visual determination of the level or amount of liquid contained in the container. In other instances, it may be impractical to visually determine the level or amount of liquid in a container. In such instances, the level or amount of the liquid must be determined by other means.

As another example, the level or amount of a liquid may be determined by way of weight. In such an example, if the weight of the container when empty is known, the amount of liquid can be determined by weighing the container to determine the weight of any contained liquid, and liquid volume can be determined through knowledge of the liquid's density (at any given temperature, which can also often be measured or estimated). In some instances, however, neither visual determination of liquid levels/amounts nor weighing of a container is practical or desired. Other methods for determining levels or amounts may then be used.

In some instances, an amount or level of a liquid in a container is determined by way of a float connected to a reporting device of some sort. The float is generally formed of some material that is buoyant in the liquid that is to be measured. The float is placed in the container in such a way as to permit the float to rise or fall with contained liquid levels, at least within certain ranges (such as until the float rests on the bottom of the container or strikes the top of the container). As the liquid level rises or falls, the buoyancy of the float causes the float to remain on the surface of the liquid. The reporting device may be any type of device that is able to report the position of the float in the liquid, such as a mechanical level indicator physically and mechanically connected to the float or an electrical level indicator that determines a change in an electrical property as a result of movement of the float. As one example of a change in an electrical property as a result of movement of the float, the float may be mechanically connected through a linkage arm to a wiper of a variable resistor. The position of the float may be determined by measuring the resistance of the variable resistor.

The issue of measuring or determining the level or amount of liquids in containers becomes more complicated in containers that may simultaneously contain multiple liquids.

### BRIEF SUMMARY OF THE INVENTION

Implementation of the invention provides systems and methods for measuring or determining the level or amount of multiple immiscible liquids of different densities in containers. The levels or amounts of the liquids is determined using multiple floats, with each float having a density less than the density of the liquid to be measured but greater than the density of the next less dense liquid (or fluid) in the container. In this fashion, the position of each float can be determined and used to determine the levels of the various liquids. According to implementations of the invention, the position of two floats can be determined using a single three-terminal potentiometer, such as a membrane potentiometer.

A method for measuring levels of multiple immiscible liquids of different densities in a container includes measuring a first electrical signal selected from the group consisting of a resistance, a voltage, and a current between a first terminal and a second terminal of a three-terminal potentiometer, the first electrical signal corresponding to a first location of actuation of the potentiometer, and measuring a second electrical signal selected from the group consisting of a resistance, a voltage, and a current between the first terminal and a third terminal of the three-terminal potentiometer, the second electrical signal corresponding to a second location of actuation of the potentiometer.

The potentiometer for the method may be disposed in a column in the container containing the immiscible liquids. The potentiometer may alternatively be disposed on a wall of the container containing the immiscible liquids. The potentiometer is a magnetically actuated potentiometer. The first and second locations of actuation of the potentiometer may correspond to locations of first and second floats contained in the container sufficiently proximate the potentiometer to permit magnetic elements of the first and second floats to magnetically actuate the potentiometer. The method may further include measuring changes in the first electrical signal and the second electrical signal. The method may further include translating the first and second electrical signals into measurements of levels of first and second immiscible liquids in the container.

A system for measuring levels of multiple immiscible liquids of different densities in a container, includes a vertically disposed three terminal potentiometer capable of magnetic actuation at two locations, a first float configured to magnetically actuate the potentiometer at a first location, and a second float configured to magnetically actuate the potentiometer at a second location that differs from the first location.

The potentiometer may be disposed within a column and the first float and the second float may be disposed in sliding engagement with the column. The column is magnetically inert. As a vertical position of the first float on the column and a vertical position of the second float on the column change, the first location of actuation of the potentiometer and the second location of actuation of the potentiometer also change. The column may contain a plurality of potentiometers, each potentiometer being configured to be magnetically actuated at two locations.

A first electrical signal corresponding to the first location can be measured between a first terminal of the potentiometer and a second terminal of the potentiometer, and a second electrical signal corresponding to the second location can be measured between the first terminal of the potentiometer and a third terminal of the potentiometer. The first and second electrical signals may be selected from the group consisting of a voltage, a current, and a resistance.

The potentiometer may be disposed outside a magnetically inert portion of the outer wall of the container. The outer wall of the container adjacent the potentiometer may be shaped to retain corresponding portions of the first float and the second float in sliding engagement with the outer wall of the container adjacent the potentiometer.

The first float and the second float may include magnets configured to magnetically actuate the potentiometer. The first float has a density configured to cause the first float to float at a surface of a first liquid of interest and the second float has a density configured to cause the second float to float at an interface between the first liquid of interest and a second liquid of interest.

A system for measuring levels of multiple immiscible liquids of different densities in a container includes a vertically disposed column contained in a container for multiple immiscible liquids of different densities, a three terminal potentiometer capable of magnetic actuation at two locations disposed along an inner wall of the column, a first float in sliding engagement with the column, the first float having a density configured to cause the first float to float at a surface of a first liquid of interest, the first float being configured to magnetically actuate the potentiometer at a first location, and a second float in sliding engagement with the column below the first float, the second float having a density configured to cause the second float to float at an interface between the first liquid of interest and a second liquid of interest, the second float being configured to magnetically actuate the potentiometer at a second location that differs from the first location. The column may contain multiple potentiometers each capable of magnetic actuation at two locations through a wall of the column by magnetic elements contained in the first float and the second float.

The methods and systems discussed herein are illustrative of implementations of the invention, and are not intended to be limiting. The scope of the invention is to be determined by reference to appended claims.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a plan view of an embodiment of a potentiometer;

FIG. 2 shows an exploded cross-sectional view of the potentiometer of FIG. 1 taken along the line 2-2 of FIG. 1;

FIG. 3 shows an exploded cross-sectional view of the potentiometer of FIG. 1 taken along the line 3-3 of FIG. 1;

FIG. 4 shows an exploded cross-sectional view of the potentiometer of FIG. 1 taken along the line 4-4 of FIG. 1;

FIG. 5 shows a cross-sectional view of the potentiometer of FIG. 1 as actuated by an external control element;

FIG. 6 shows a cross-sectional view of the potentiometer of FIG. 1 as actuated by an external control element, the view being orthogonal to the view of FIG. 5;

FIG. 7 shows a plan view of an embodiment of a potentiometer;

FIG. 8 shows an exploded cross-sectional view of the potentiometer of FIG. 7 taken along the line 8-8 of FIG. 7;

FIG. 9 shows an exploded cross-sectional view of the potentiometer of FIG. 7 taken along the line 9-9 of FIG. 7;

FIG. 10 shows an exploded cross-sectional view of the potentiometer of FIG. 7 taken along the line 10-10 of FIG. 7;

FIG. 11 shows a plan view of an embodiment of a potentiometer;

FIG. 12 shows a top view of the potentiometer of FIG. 11 with a top cover removed and a magnetic tap inserted therein;

FIG. 13 shows a top view of a potentiometer similar to the potentiometer of FIG. 7, showing multiple points of actuation;

FIG. 14 shows a top view of a potentiometer similar to the potentiometer of FIG. 11, showing multiple points of actuation; and

FIG. 15 shows a perspective view of an embodiment of a level measurement assembly.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for measuring or determining the level or amount of multiple immiscible liquids of different densities in containers. The levels or amounts of the liquids is determined using multiple floats, with each float having a density less than the density of the liquid to be measured but greater than the density of the next less dense liquid (or fluid) in the container. In this fashion, the position of each float can be determined and used to determine the levels of the various liquids. According to embodiments of the invention, the position of two floats can be determined using a single three-terminal potentiometer, such as a membrane potentiometer.

A method for measuring levels of multiple immiscible liquids of different densities in a container includes measuring a first electrical signal selected from the group consisting of a resistance, a voltage, and a current between a first terminal and a second terminal of a three-terminal potentiometer, the first electrical signal corresponding to a first location of actuation of the potentiometer, and measuring a second electrical signal selected from the group consisting of a resistance, a voltage, and a current between the first terminal and a third terminal of the three-terminal potentiometer, the second electrical signal corresponding to a second location of actuation of the potentiometer.

The potentiometer for the method may be disposed in a column in the container containing the immiscible liquids. The potentiometer may alternatively be disposed on a wall of the container containing the immiscible liquids. The potentiometer is a magnetically actuated potentiometer. The first and second locations of actuation of the potentiometer may correspond to locations of first and second floats contained in the container sufficiently proximate the potentiometer to permit magnetic elements of the first and second floats to magnetically actuate the potentiometer. The method may further include measuring changes in the first electrical signal and the second electrical signal. The method may further include translating the first and second electrical signals into measurements of levels of first and second immiscible liquids in the container.

A system for measuring levels of multiple immiscible liquids of different densities in a container, includes a vertically disposed three terminal potentiometer capable of magnetic actuation at two locations, a first float configured to magnetically actuate the potentiometer at a first location, and a second float configured to magnetically actuate the potentiometer at a second location that differs from the first location.

The potentiometer may be disposed within a column and the first float and the second float may be disposed in sliding engagement with the column. The column is magnetically inert. As a vertical position of the first float on the column and a vertical position of the second float on the column change, the first location of actuation of the potentiometer and the second location of actuation of the potentiometer also change. The column may contain a plurality of potentiometers, each potentiometer being configured to be magnetically actuated at two locations.

A first electrical signal corresponding to the first location can be measured between a first terminal of the potentiometer and a second terminal of the potentiometer, and a second electrical signal corresponding to the second location can be measured between the first terminal of the potentiometer and a third terminal of the potentiometer. The first and second electrical signals may be selected from the group consisting of a voltage, a current, and a resistance.

The potentiometer may be disposed outside a magnetically inert portion of the outer wall of the container. The outer wall of the container adjacent the potentiometer may be shaped to retain corresponding portions of the first float and the second float in sliding engagement with the outer wall of the container adjacent the potentiometer.

The first float and the second float may include magnets configured to magnetically actuate the potentiometer. The first float has a density configured to cause the first float to float at a surface of a first liquid of interest and the second float has a density configured to cause the second float to float at an interface between the first liquid of interest and a second liquid of interest.

A system for measuring levels of multiple immiscible liquids of different densities in a container includes a vertically disposed column contained in a container for multiple immiscible liquids of different densities, a three terminal potentiometer capable of magnetic actuation at two locations disposed along an inner wall of the column, a first float in sliding engagement with the column, the first float having a density configured to cause the first float to float at a surface of a first liquid of interest, the first float being configured to magnetically actuate the potentiometer at a first location, and a second float in sliding engagement with the column below the first float, the second float having a density configured to cause the second float to float at an interface between the first liquid of interest and a second liquid of interest, the second float being configured to magnetically actuate the potentiometer at a second location that differs from the first location. The column may contain multiple potentiometers each capable of magnetic actuation at two locations through a wall of the column by magnetic elements contained in the first float and the second float.

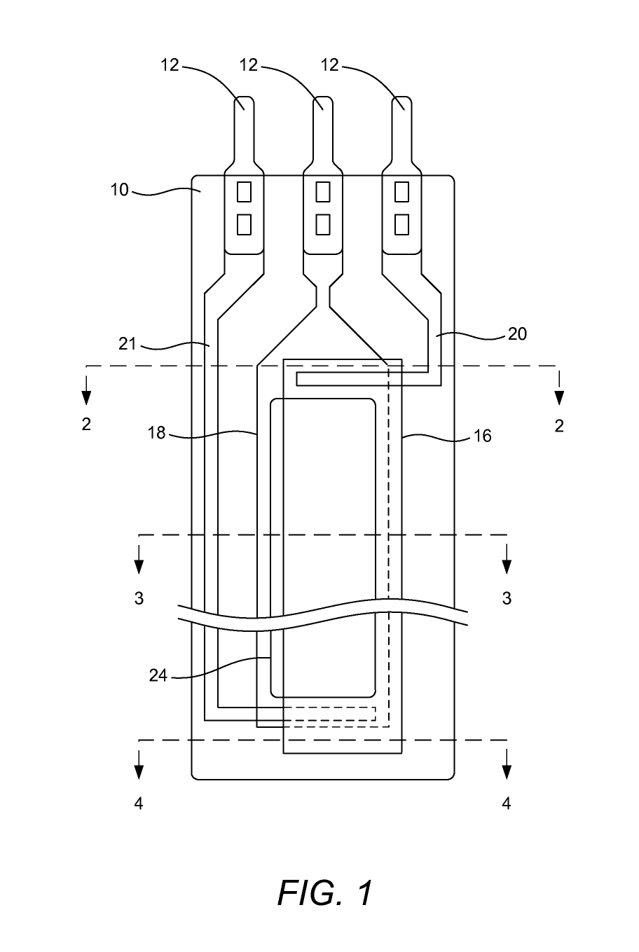

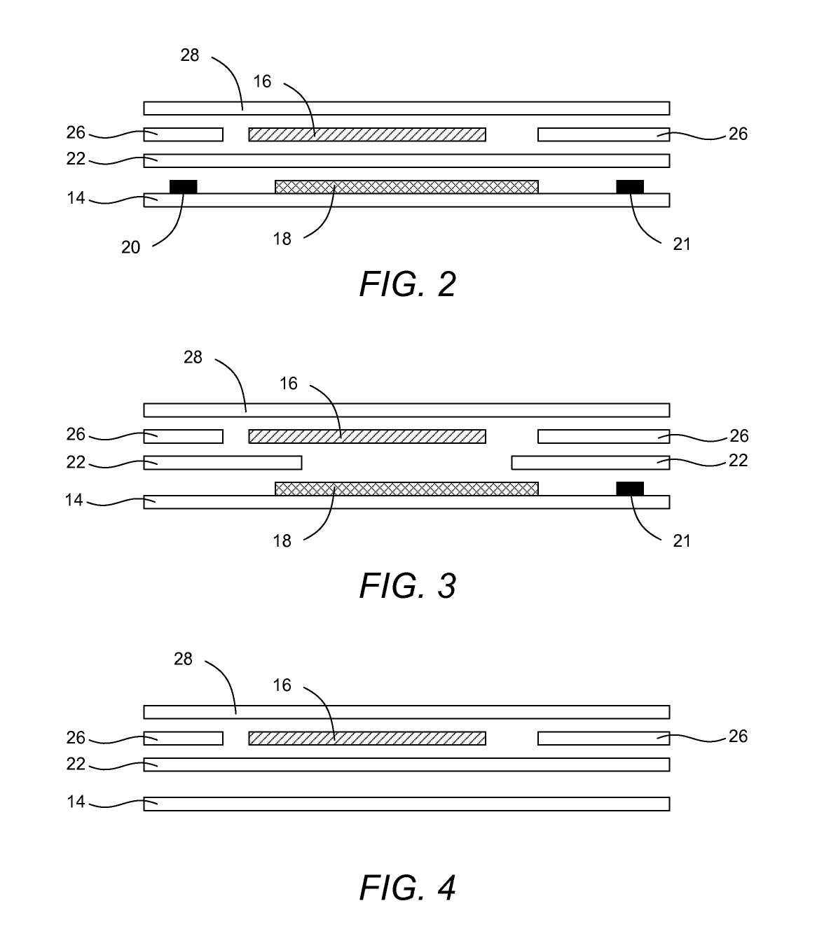

FIGS. 1 through 4 illustrate the components of one example of a film or membrane potentiometer (hereinafter “potentiometer 10”) such as is described in U.S. Pat. No. 8,138,860, which is incorporated herein by reference for all it discloses. FIG. 1 shows a plan view of an embodiment of the potentiometer, while FIGS. 2-4 show exploded cross-sectional views of the embodiment of FIG. 1 at the locations shown by lines 2-2, 3-3, and 4-4, respectively. The potentiometer 10 may be a linear slide potentiometer having three connection terminals 12, as is well-known in the art of potentiometers. The terminals 12 facilitate making connections with the potentiometer for electrical circuits, as is known in the art. Each of the terminals 12 may be physically and electrically connected to one of three paths on a non-conductive backing 14 (see FIGS. 2-4). The backing 14 may be relatively thin and non-conductive, and may be made of a non-magnetic heat-resistive material such as epoxy or various types of plastic. The backing 14 provides structural support and strength for the potentiometer 10, as well as insulating the internal components of the potentiometer 10 from unwanted electrical contact. The overall length of the potentiometer 10 shown in FIG. 1 as well as the lengths of the exemplary paths/traces discussed below may be varied to suit the needs of the specific application in which the potentiometer 10 will be used.

As shown in FIG. 1, the rightmost terminal 12 is electrically connected by a first conductive bus bar 20 to a conductive trace 16 that may be a conductive path or conductive foil made from or incorporating any number of conductive ferromagnetic materials. As non-limiting examples, the conductive trace 16 may be made of substantially pure iron, carbon steel, any other sufficiently ferromagnetic and conductive alloy, or may be made of other conductive materials such as gold or silver attached to a ferromagnetic backing as will be discussed in more detail later. In FIG. 1, the left two terminals 12 are connected in an electronic loop that passes through a resistive trace 18 and a second conductive bus bar 21 in series, as is known in the potentiometer art. The first bus bar 20 and the second bus bar 21 may be of differing widths or thicknesses, and may be on the same or different layers of the potentiometer 10, as will be appreciated from FIGS. 2-4 and the accompanying discussion. All of the conductive trace 16, the resistive trace 18, and the bus bars 20, 21 may be placed above the top surface of the backing 14 so as to be electrically insulated from the bottom surface of the backing 14. As will be appreciated from FIGS. 2-4, the conductive trace 16 and the resistive trace 18 are configured to lie in different planes from one another, and one or both of the bus bars 20, 21 may lie on varying planes either on the same plane as one of the conductive trace 16 and the resistive trace 18, or on some other plane, according to manufacturing or design requirements.

Although FIG. 1 shows each of the terminals 12 exiting from one side of the potentiometer 10, the layout shown in FIG. 1 may be varied to place the location of the terminals 12 at different positions than shown, as long as the characteristics of the electrical connections between elements are maintained. These types of variations are known in the art to facilitate connection of the potentiometer 10 in whatever way is most useful for the particular application. The various paths, traces, and bus bars may be routed around mounting holes or any variety of other shape configurations of the backing 14 to allow the potentiometer 10 to be fixedly mounted within or for an electrical application, etc.

The resistive trace 18 may be formed by any number of materials and processes known in the art of forming such resistive paths or traces. The resistive trace 18 may be of a thickness similar to conductive trace 16, or may be of a different thickness. The resistive trace 18 may be made of a special conductive resistor that is laid down on the backing 14, as is commonly used for slide or linear potentiometers.

As is more clearly shown in FIGS. 2-4, disposed between the resistive trace 18 and the conductive trace 16 is a non-conductive circuit spacer 22. The circuit spacer 22 physically separates the conductive trace 16 from the resistive trace 18 and may be placed on top of the backing 14 (and may also be placed on top of a portion of the resistive trace 18 and one or more of the bus bars 20, 21) and may be attached to the backing 14. The spacer 22 may be constructed of any material that does not provide an electrical connection between the various terminals 12, traces 16, 18 and bus bars 20, 21. Non-limiting examples of such materials include ceramics and many types of plastics. Further, the method of attaching the circuit spacer 22 to the backing 14 may be done by any method that does not provide any electrical connections between the terminals 12, traces 16, 18, and bus bars 20, 21. Non-limiting methods that may be used to attach the circuit spacer 22 to the backing 14 include gluing and laminating. As may be appreciated, the means used to attach the circuit spacer 22 may be varied to be suitable for the particular use of the potentiometer 10, such as anticipated operating temperature, anticipated flexion of the potentiometer 10, etc.

The circuit spacer 22 includes a cut-out or window (“window 24”) that permits physical and electrical contact between a location of the conductive trace 16 and a corresponding location of the resistive trace 18 upon application of a force that brings the two traces 16, 18 together. The circuit spacer 22 and window 24 may also simultaneously seal the perimeter of the potentiometer 10 against the entry of foreign particles or environmental contaminants. As may be appreciated by one of skill in the art, the resistance between the rightmost terminal 12 and either of the two left terminals 12 may be varied by moving the location of physical and electrical contact between the conductive trace 16 and the resistive trace 18 longitudinally within the window 24.

The conductive trace 16, as set forth above and shown in FIGS. 2-4, is separated from the resistive trace 18 by the circuit spacer 22. The conductive trace 16 may have a length that is somewhat longer than the length of the window 24, as shown in FIG. 1. The conductive trace 16 in some embodiments is positioned offset to the window 24, whereby one edge and both ends of the conductive trace overlap the circuit spacer 22 adjacent the window 24 and whereby the second edge of the conductive trace 16 is positioned within the area above the window 24 except at the ends of the conductive trace 16. This positioning of the conductive trace 16 is shown in FIGS. 1 and 3.

The ends of the conductive trace 16 may be fixed to the circuit spacer 24. Attaching the ends of the conductive trace 16 secures the position of the conductive trace 16 relative to the window 24 and the resistive trace 18. In some embodiments, the edge of the conductive trace 16 positioned over the circuit spacer 24 may not be attached to the circuit spacer 24, while in other embodiments, the edge of the conductive trace 16 positioned over the circuit spacer 24 may be attached to the circuit spacer. Whether or not to attach the first edge of the conductive trace 16 to the circuit spacer 24 may be determined by the desired flexibility of the conductive trace 16 to permit making of electrical contact between the conductive trace 16 and the resistive trace 18 upon application of a certain minimum force on the conductive trace 16. Attaching the first edge of the conductive trace 16 to the circuit spacer 24 may require additional force on the conductive trace 16 to cause contact between the conductive trace 16 and the resistive trace 18.

In FIG. 1, the first bus bar 20 is shown connected to the conductive trace 16 near the terminal end of the potentiometer 10. In alternate embodiments, the first bus bar 20 may be connected to the conductive trace 16 at a different location, including along the entire length of the conductive trace 16 or at the distal end of the conductive trace 16. Additionally, although the first bus bar 20 is shown in FIG. 2 as being in the same plane as the resistive trace 18, it should be understood that the first bus bar 20 may instead be located in the same plane as the conductive trace 16 or in some other plane. In some embodiments, as illustrated in FIGS. 2-4, it may be desirable to seal the potentiometer 10 against dust, etc., and therefore, in some embodiments, one or more non-conductive foil spacers 26 may be placed around the conductive trace 16, with a top cover 28 placed over the conductive trace 16 and the foil spacers 26. The foil spacer(s) 26 may have a thickness equal to or greater than the thickness of the conductive trace 16 (which may be a conductive foil) to provide an opening or window between the circuit spacer 22 and the top cover 28 and within the foil spacer(s) housing the conductive trace 16.

The top cover 28 and the foil spacer(s) 26 are considered an optional feature of embodiments of the potentiometer 10, as not all uses of the potentiometer 10 will require that the potentiometer 10 be sealed. The top cover 28 and the foil spacer(s) 26 are illustrated in FIGS. 2-4 but are not illustrated in FIG. 1 for clarity of FIG. 1 and to illustrate the fact that they are optional features of some potentiometers 10. As described above, FIGS. 2-4 depict exploded cross-sectional views of the potentiometer 10 at the locations of lines 2-2, 3-3, and 4-4 shown on FIG. 1, respectively. These Figures illustrate one embodiment of the various layers of the potentiometer 10. By way of illustration and clarity only, the various layers of the potentiometer 10 are illustrated as being of substantially equal thicknesses. Such is not the case in many actual examples of the potentiometer 10. By way of example, the backing 14 and the top cover 28 may have thickness of about 0.005 inches while the resistive trace 16 has a thickness of about 0.002 inches. The thicknesses of the circuit spacer 22 and the foil spacer(s) 26 may also vary from the other thicknesses as needed, and additional spacers may be included to form a complete potentiometer package.

At the location of the potentiometer 10 illustrated in FIG. 2, the first bus bar 20 has not yet connected to the conductive trace 16, and the circuit spacer 22 is solid, not having the window 24 to permit contact between the conductive trace 16 and the resistive trace 18. In contrast, at the position illustrated in FIG. 3, the first bus bar 20 has connected to the conductive trace 16 (and is therefore no longer shown in this view). In addition, this location is within the window 24 formed in the circuit spacer 22, and a force that causes the free end of the conductive trace 16 to move sufficiently toward the resistive trace 18 will be permitted to cause the conductive trace 16 to make physical and electrical contact with the resistive trace 18. Finally, at the location of the potentiometer 10 illustrated in FIG. 4, the distal end of the conductive trace 16 is extended beyond the window 24, permitting the end of the conductive trace 16 to be attached to the circuit spacer 22 (and/or to the top cover 28, if present). In some examples, the resistive trace 18 may extend this distance, along with one or more of the bus bars 20, 21, although no particular advantage is obtained by such extension.

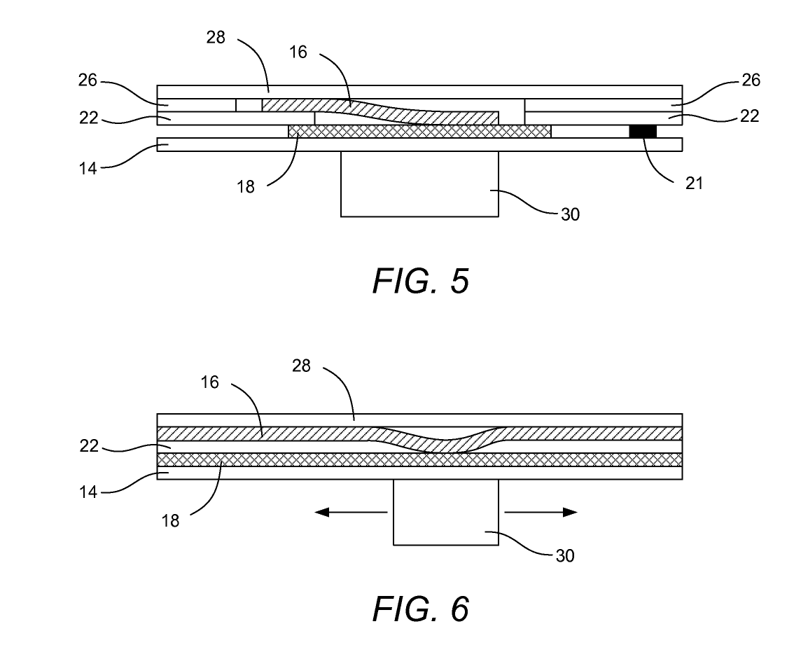

As has been discussed, a force is required to cause a portion of the conductive trace 16 to contact a portion of the resistive trace 18, thereby outputting a meaningful electrical reading from the potentiometer 10. In embodiments of the potentiometer 10, this force is a magnetic force, and may be provided by an external control element 30, as illustrated in FIGS. 5-6. FIGS. 5-6 show representative orthogonal cross-sectional views (not exploded) of embodiments of the potentiometer 10, illustrating the function of the magnetic force as applied by the control element 30. The magnetic force is applied through the backing 14 and resistive trace 18 to attract a portion of the conductive trace 16 in the direction of the resistive trace 18. The magnetic force may be applied by any means known in the art, including, but not limited to, one or more permanent magnets and one or more electromagnets. Examples of permanent magnets that may be used with embodiments of the invention include various grades of neodymium-iron-boron NdFeB or other “rare-earth” magnets.

The magnitude of the magnetic force may be varied by way of experimentation to achieve the best characteristics and functionality of the potentiometer 10 according to the desired use, including the uses discussed in more detail below. By way of non-limiting example, the magnetic force may be varied by changing the strength of the applied magnetic force, such as by varying the grade, number, or size of external magnets used by the external control element 30. Additionally, the magnetic force may be varied by changing the distance of the applied magnetic force from the potentiometer, as magnetic force decreases with increasing distance. The distance may be changed by making the backing 14 thicker or thinner, the thickness of the circuit spacer 22 thicker or thinner, or by variations provided by the external control element 30 or other objects between the conductive trace 16 and any magnets of the external control element 30.

As another example by which the magnetic force may be varied is by changing the thickness and/or width of the conductive trace 16 or by changing the materials of the conductive trace. While substantially pure iron will theoretically be subject to more magnetic force than some other ferromagnetic materials such as steel, the cost of substantially pure iron foil for use as the conductive trace 16 may make the use of pure iron impractical. Therefore, while such foils can be used with embodiments of the invention, sufficient magnetic forces may be achieved by materials such as 1008 carbon steel, either alone or in conjunction with other materials.

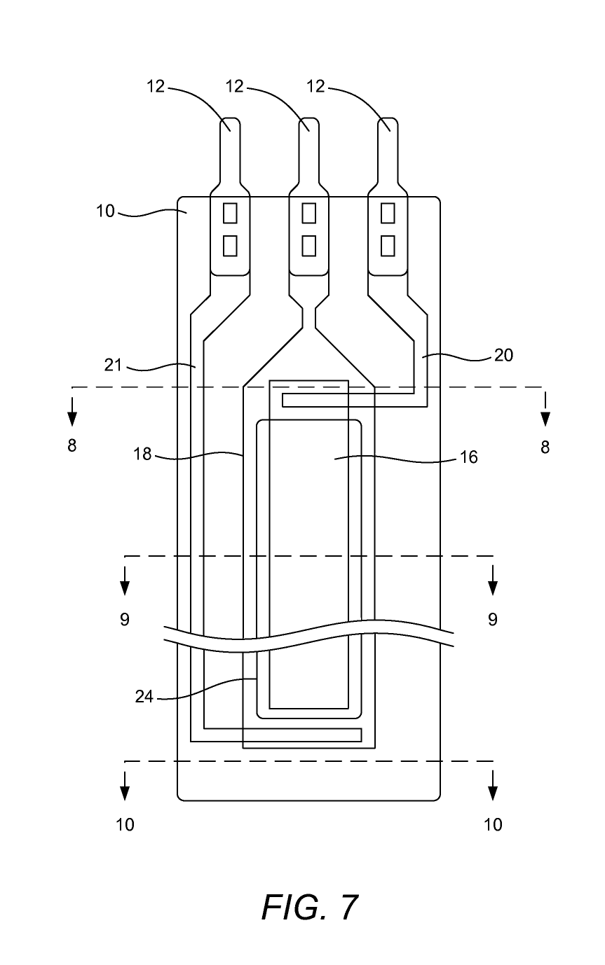

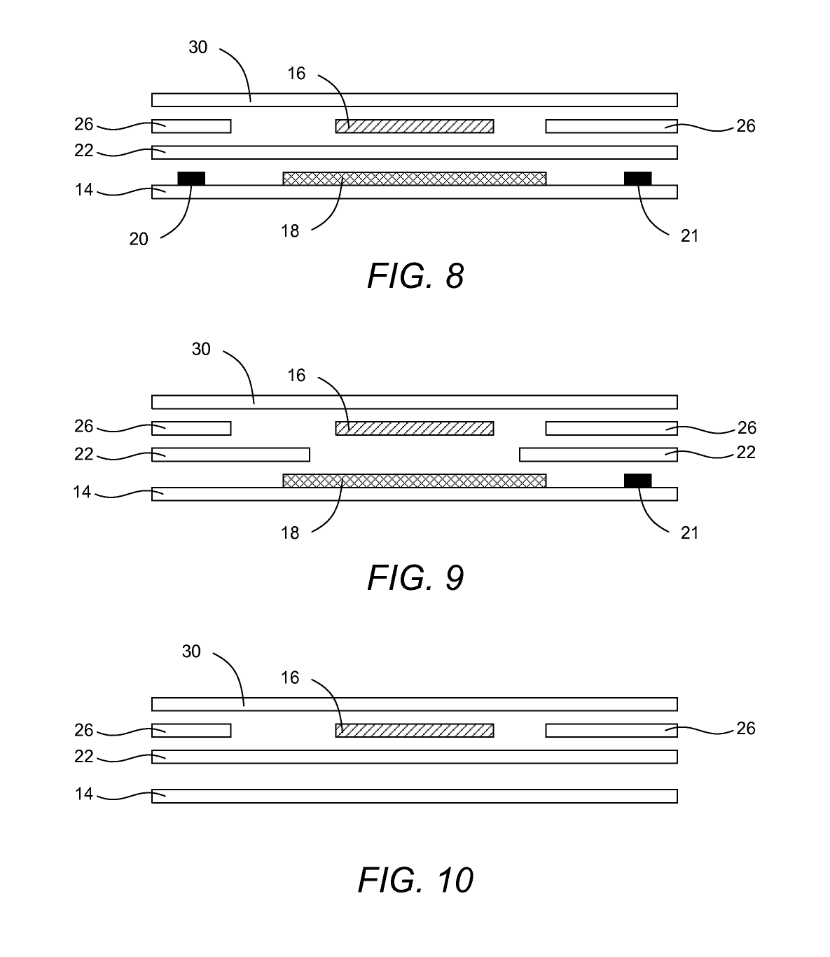

Another example by which the magnetic force may be varied is by the addition of and/or variation of a magnetic layer (e.g. a sheet magnet 33 replacing the top cover 28 as shown in FIGS. 8-10) opposite to the conductive trace 16 from the resistive trace and in place of the top cover 28, as discussed below with respect to FIGS. 7-10. The strength of the magnetic force of the sheet magnet 32 may be varied to oppose movement of the conductive trace 16 toward the resistive trace 18.

Alternatively, a magnetic layer or a layer of material of relatively-high magnetic permeability may be secured to the conductive trace 16 itself. If a magnetic layer is added opposite to the conductive trace 16, it may or may not contribute to conductivity of the conductive trace 16. The magnetic layer may include a ferromagnetic material or a magnetic material to further provide variability of the magnetic force. In at least some embodiments, the conductive trace 16 may be bonded or otherwise attached to the magnetic layer. For example, the conductive trace 16 may be a silver conductive material or alloy printed onto or otherwise bonded to the magnetic layer. It should be understood that two or more of the manners of varying the magnetic force discussed herein may be used in conjunction.

FIGS. 5-6 show examples of how the conductive trace 16 may deform under magnetic force (such as applied by the external control element 30) to locally contact the resistive trace 18. While FIG. 5 shows a cross sectional view taken across the width of the potentiometer 10 at a cross-sectional location similar to that shown in FIG. 3, FIG. 6 shows an exemplary lengthwise (i.e. orthogonal to FIG. 5) cross-sectional view, showing how longitudinal displacement of the external magnetic force will cause a different reading from the potentiometer 10 as the length of the resistive trace 18 prior to the point of contact changes.

FIGS. 7 through 10 illustrate the components of another embodiment of a film or membrane potentiometer 10. FIG. 7 shows a plan view of an embodiment of the potentiometer, while FIGS. 8-10 show exploded cross-sectional views of the embodiment of FIG. 7 at the locations shown by lines 8-8, 9-9, and 10-10, respectively. In this alternate type of embodiment, as little as one end of the conductive trace 16 overlaps the circuit spacer 22 proximate the terminals 12, and the other edges of the conductive trace 16 are contained entirely within the boundary defined by the window 24. As may be appreciated, such an embodiment may potentially require less attractive force to cause a portion of the conductive trace 16 to move toward the resistive trace 18 along the majority of the length of the conductive trace 16, as the movement of the conductive trace 16 toward the resistive trace 18 is not impeded by interference of the circuit spacer 22 surrounding the window 24. In such an embodiment, to prevent unwanted contact between the conductive trace 16 and the resistive trace 18, the top cover 28 of the embodiments of FIGS. 1-4 may be replaced by the sheet magnet 32 having a sufficiently-strong magnetic field to normally attract the conductive trace 16 away from the resistive trace 18. As discussed above, the magnetic strength of the sheet magnet 32 may be varied as desired in combination with the magnetic force of the external control element 30 to obtain desired performance characteristics.

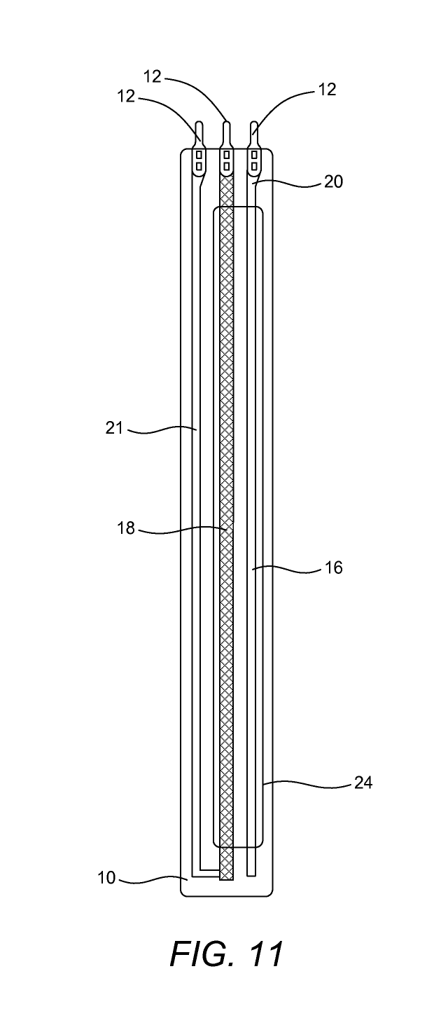

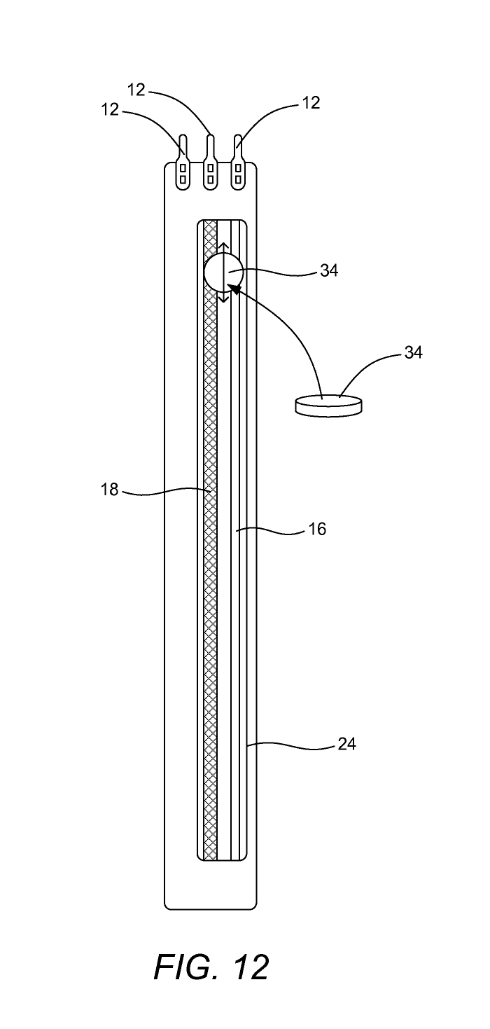

The potentiometers 10 illustrated in FIGS. 1-10 are merely examples of three-terminal potentiometers that may be used to permit measurement of multiple levels of immiscible liquids of different densities in a container. Another type of potentiometer 10 that may be used to permit measurement of multiple levels of immiscible liquids of different densities in a container is illustrated in FIGS. 11-12. Many of the features of this type of potentiometer 10 are disclosed in Patent Application Publication No. 2008/0164970, which is incorporated by reference for all it discloses. As seen in FIG. 11, which is a transparent view, this type of potentiometer 10 also has three terminals 12, but the resistive trace 18, the conductive trace 16, and the bus bars 20, 21 are all basically disposed in a co-planar relationship on a backing similar to backing 14 discussed above, instead of with the conductive trace 16 disposed above the resistive trace 18. As with the previously-discussed potentiometers 10, two of the terminals 12 are electrically connected to opposite ends of the resistive trace 18, and a non-conductive space is provided between the conductive trace 16 and the resistive trace 18. A circuit spacer similar to circuit spacer 22 defines a window 24 that exposes adjacent portions of the conductive trace 16 and the resistive trace 18.

In this type of potentiometer 10, a local connection is made between the conductive trace 16 and the resistive trace 18 by a magnetic tap 34, as illustrated in FIG. 12, in which the circuit spacer has been made opaque to highlight the window 24. The magnetic tap 34 electrically bridges the gap between the conductive trace 16 and the resistive trace 18, and a reading may be taken from the terminals 12 to determine the location of the magnetic tap 34. The magnetic tap 34 may be controlled by an external control element similar to the external control element 30 discussed above, and the forces applied between the magnetic tap 34 and the external control element may be varied in fashions similar to those discussed above. The magnetic tap 34 is contained within the window 24, and may be retained in the window 24 by a top cover (not shown) similar to top cover 28. The circuit spacer may be chosen to have a thickness similar to the thickness of the magnetic tap 34. The exact shape of the magnetic tap 34 is not of particular importance as long as it is ensured that the magnetic tap 34 will not bind as it is displaced within the window 24 and as long as it is ensured that the magnetic tap 34 reliably bridges the gap between the conductive trace 16 and the resistive trace 18 at the location of the magnetic trap 34.

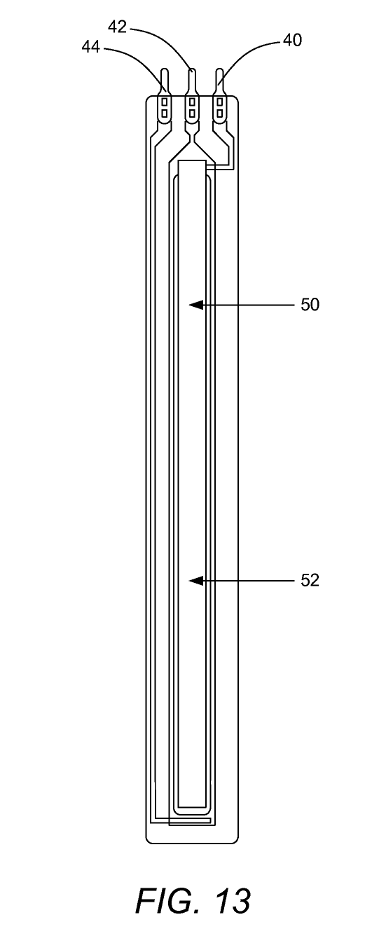

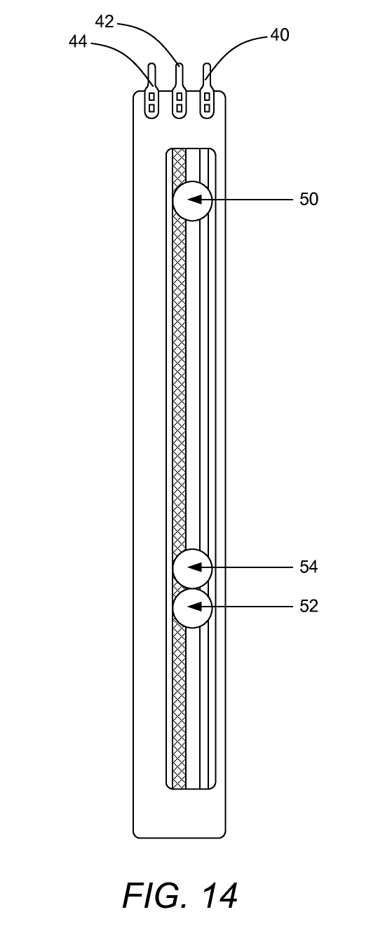

FIGS. 13 and 14 illustrate the manner in which various embodiments of three-terminal potentiometers 10 may be used to simultaneously permit detection of two points of interest along the potentiometer length. FIG. 13 illustrates an embodiment similar to the embodiment of FIGS. 7-10 and FIG. 14 illustrates an embodiment similar to the embodiment of FIGS. 11-12, showing that the function is similar regardless of the embodiment used. In either instance, the potentiometer 10 has three terminals 12, a first terminal 40, a second terminal 42, and a third terminal 44. In either instance, the first terminal 40 is electrically connected to the conductive trace 16, the second terminal 42 is electrically connected to one end of the resistive trace 18, and the third terminal 44 is electrically connected to the other end of the resistive trace 18. Thus, the second terminal 42 and the third terminal 44 are electrically connected to each other through the resistive trace.

In either example, electrical connections are made between the conductive trace 16 and the resistive trace 18 at two points of interest. These two points of interest correspond, for example, to the levels of two immiscible liquids of different densities in a container. When two electrical connections are made at different lengthwise points between the conductive trace 16 and the resistive trace 18, the three-terminal potentiometer 10 effectively serves as two two-terminal rheostats or variable resistors. For purposes of the following discussion, assume the potentiometer is disposed vertically in exactly the manner shown in FIGS. 13 and 14. A point of an upper connection 50 can be determined by measuring an electrical characteristic (resistance, voltage, or current) between the first terminal 40 and the second terminal 42. Meanwhile, a point of a lower connection 52 can simultaneously be determined by measuring an electrical characteristic (resistance, voltage, or current) between the first terminal 40 and the third terminal 44. The upper connection 50 and the lower connection are made by magnetic forces applied by two separate external control devices 30, and may be moved independently upward and downward on the potentiometer 10.

It should be noted that care should be taken with the use of the embodiment of FIG. 14 to ensure that the two magnetic taps 34 do not interact with each other, so the embodiment of FIG. 14 may not be appropriate for all uses where a single three-terminal potentiometer is used to provide two location determinations. Alternately, an appropriately sized non-magnetic spacer 54, or a plurality thereof, may be used to separate the two magnetic taps 34. The non-magnetic spacer 54 is magnetically inert, whereby it does not magnetically interact with the magnetic taps 34 or the external control element 30. Where present, the non-magnetic spacer 54 is free to move within the window 34 and will typically rest on top of the lower magnetic tap 34 when the potentiometer 10 is disposed vertically. Alternatively or additionally, the magnetic taps 34 may be disposed within the window 24 with opposite polarity such that the respective magnetic taps 34 will only properly interact with certain external control elements 30 having matching polarities.

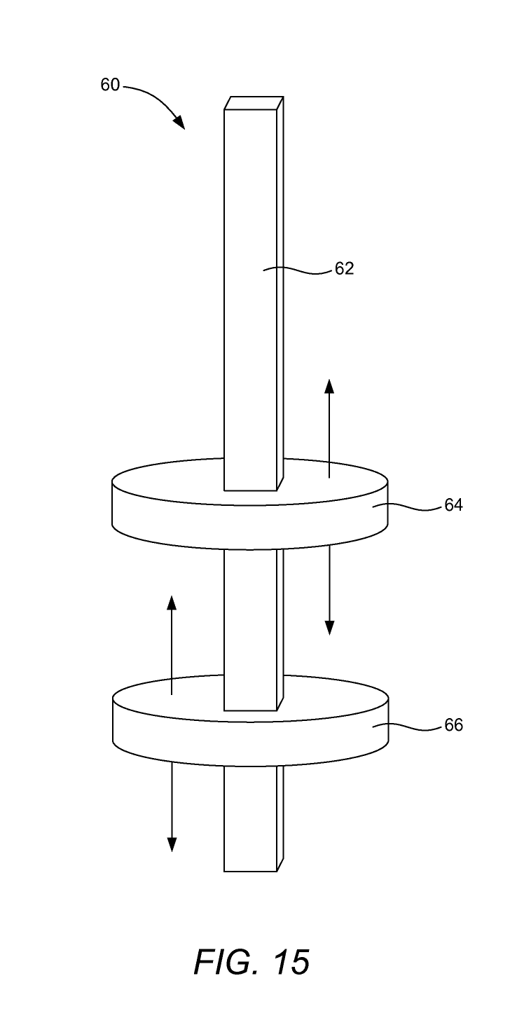

FIG. 15 shows a level measurement assembly 60 applying the concepts discussed with respect to FIGS. 13 and 14 and suitable for use in measuring the levels of two immiscible liquids in a container. The level measurement assembly 60 includes a column 62. An upper float 64 and a lower float 66 are in sliding engagement with the column 62, such that the upper float 64 and the lower float 66 are free to move up and down on the column 62. While the column 62 is illustrated as having a square cross-section and the upper float 64 and the lower float 66 are illustrated as circular discs, the column 62, upper float 64, and lower float 66 may have any desired shape or cross section.

The column 62 is hollow and has at least one potentiometer 10 disposed therein, such as one of the potentiometers discussed with respect to FIGS. 1-14. Assuming the column 62 contains a single potentiometer 10, the length of the potentiometer 10 is selected to correspond to a full range of interest for levels of liquids in the container. Thus, if the entire container is of interest, the column 62 may be sized to fill the container from top to bottom, and the potentiometer 10 contained within the column 62 is sized to extend from top to bottom of the column 62.

The column 62 may be made of a variety of possible materials of varying thicknesses, but the column material is chosen based on certain design considerations. First, the column material is selected to be compatible with the liquids to be stored in the container. For example, the column material is chosen so as not to corrode when exposed to the liquids to be stored in the container. Second, the column material is selected such that there is little to no magnetic interaction between the column material and magnetic control elements in the upper float 64 and the lower float 66, otherwise up and down movement of the upper float 64 and the lower float 66 as liquid levels changed would be constrained. Third, the column material is selected so as to permit actuation of the potentiometer 10 through the column material. Thus, the column material should be chosen to permit transmission of magnetic interaction between the magnetic control elements in the upper float 64 and the lower float 66 and the potentiometer 10 (e.g. the conductive trace 16 or attached magnetic layer or the magnetic taps 34). By way of example only, the column 62 may be made of aluminum, copper, certain compositions of stainless steel, plastics, and the like.

The upper float 64 may be manufactured of any desired material and shape, but has two defining characteristics. First, the upper float 64 has a density that is less than the less dense of the two liquids whose levels in the container are of interest. This ensures that the upper float 64 floats on the surface of the less dense of the two liquids, at least until the upper float 64 reaches the maximum upward position it can reach within the container or rests on or impacts the lower float 66. Second, the upper float has a magnetic control element configured to actuate the potentiometer 10 contained within the column 62.

Similarly, the lower float 66 has two defining characteristics. First, the lower float 64 has a density that is more than the less dense of the two liquids whose levels in the container are of interest, but a density that is less than the more dense of the two liquids whose levels in the container are of interest. This ensures that the lower float 66 floats on the boundary between the two liquids, at least until the lower float 66 reaches the maximum downward position it can reach within the container or contacts the upper float 64.

The magnetic control elements of the upper float 64 and the lower float 66 may be or include any type of magnetic device of sufficient strength to permit actuation of the potentiometer 10 within the column 62. By way of example, the magnetic control elements may include strong permanent magnets just under an inner surface of the upper float 64 and the lower float 66. Examples of permanent magnets that may be used with embodiments of the invention include various grades of neodymium-iron-boron NdFeB or other “rare-earth” magnets. As another example, the magnetic control elements may include electromagnets. As may be appreciated, where an electromagnet is used as part of the magnetic control element, a means for supplying power to the electromagnet will be supplied, such as by wires extending from the electromagnet of the respective float 64, 66 to an external power supply.

When the level measurement assembly 60 is assembled, the potentiometer 10 is disposed in the column 62 along one side of the column 62, with the backing 14 side of the potentiometer 10 closest to the wall of the column 62. The potentiometer 10 may be fixedly attached to the wall of the column 62, or the magnetic interaction between the potentiometer 10 and the magnetic control elements of the upper float 64 and the lower float 66 may be sufficient to ensure that the potentiometer 10 remains against the wall of the column 62. The upper float 64 and the lower float 66 are placed about the column 62, with their respective magnetic control elements positioned such that the magnetic control elements are located on a same side of the column 62 as the potentiometer 10 is located, so the magnetic control elements can interact with the potentiometer 10 in the manner described.

Leads are connected to the terminals 12 of the potentiometer, and the level measurement assembly 60 is disposed within a container. The column 62 may be disposed in the container in such a way as to prevent any liquids contained in the container from entering the column 62, or the column 62 may be permanently or reversibly sealed to prevent entry of the liquids. Such sealing may be by any mechanism known in the art for preventing entry of liquids, and may be selected based at least in part on the environment for use of the level measurement assembly 60, including the liquids in which the level measurement assembly 60 is located. While the column 62 is originally hollow to permit disposition of the potentiometer 10, the column 62 may optionally even be filled with an inert material to protect the potentiometer 10 therein.

While assembly of the level measurement assembly 60 has been described with respect to a series of assembly steps, it should be understood that the level measurement assembly 60 may be assembled in any step order. For example, leads may be connected to the potentiometer 10 before or after the potentiometer 10 is inserted into the column 62. Similarly, the potentiometer 10 may be inserted into the column 62 before or after the column 62 is inserted into a container. The upper float 64 and the lower float 66 may be disposed on the column 62 before or after the column 62 is inserted into the container and before or after the potentiometer 10 is inserted into the column.

The upper float 64 and the lower float 66 may be manufactured or formed using a variety of processes and components, and may be formed as unitary elements, or may be formed in pieces that are then assembled about the column 62. The forming or manufacturing process includes manufacturing one or more magnetic elements configured to actuate the potentiometer 10 as has been discussed above. The magnetic elements of the upper float 64 and the lower float 66 serve as the external control elements 30 discussed previously.

While the column 62 is shown in FIG. 15 as having the upper float 64 and the lower float 66 essentially symmetrically disposed around it, other configurations are possible. In some instances, it may be less practical to have a level measurement assembly 60 and column 62 of the type shown in FIG. 15, such as if it is desirable to have the level measurement assembly 60 immediately adjacent a side of the container. Thus, the column 62, the upper float 64 and the lower float 66 may be modified as desired to permit functionality similar to that discussed herein. For example, the column 62 may be made thin with edge lips that just engage the upper float 64 and the lower float 66. As another example, the column 62 may be manufactured into a side of the container itself, with a part of the container formed to guide the upper float 64 and the lower float 66 within the container. The potentiometer 10 could then be disposed outside the container while still maintaining its level-sensing functionality. The container, or the portion thereof providing the level-sensing functionality discussed herein, would be manufactured of a material permitting the level sensing functions discussed herein.

In some instances, it may be impractical to provide a single potentiometer 10 covering an entire expected range of level measurements. Alternatively, it may simply be desirable to provide level sensing with multiple potentiometers 10, such as to permit the sensing levels of more than two immiscible liquids or to provide better localization of the sensed levels. Thus, for example, the hollow column 62 of FIG. 15 could house multiple potentiometers 10 capable of being actuated by magnetic elements of the upper float 64 and the lower float 66.

In a first example, multiple potentiometers 10 may be located one above the other along a single side of the column 62. As the upper float 64 and the lower float 66 rise and fall, they will transition between two potentiometers 10, and readings can then be taken from whatever potentiometers 10 are actuated by the upper float 64 and the lower float 66, or from whatever potentiometer 10 is actuated twice: once by the upper float 64 and the lower float 66. While such an arrangement may function in many situations, there may be a question of a gap between coverage of the vertically adjacent potentiometers 10. This potential gap may be addressed in one of several manners.

In a first manner of addressing any gap in coverage between potentiometers 10, the measuring system may keep a history of locations of the upper float 64 and the lower float 66, and when no reading is received, the system may determine that the respective float 64, 66 is located at a point between the potentiometers 10, which is of itself a level determination. In a second manner of addressing any gap in coverage between potentiometers 10, potentiometers 10 may be disposed on more than one inner surface of the column 62. By way of example, the column 62 of FIG. 15 has four sides, and could have potentiometers 10 disposed on any or all of the four sides. In such a configuration, the upper float 64 and the lower float 66 may be modified to have magnetic control elements disposed on multiple sides as well, configured to interact with as many of the sides of the column 62 as have potentiometers 10 disposed therein. Thus, if two sides of the column 62 have potentiometers 10 disposed therein, the upper float 64 and/or the lower float 66 may contain two magnetic control elements configured to actuate the potentiometers 10 on those two sides. Similarly, if three or four sides of the column 62 have potentiometers 10 disposed therein, the upper float 64 and/or the lower float 66 may have magnetic control elements on three or four sides, respectively.

In configurations where potentiometers 10 are disposed on multiple sides of the column 62, the potentiometers 10 may be placed so their respective lengths overlap. In this way, there is no gap in coverage as the upper float 64 and the lower float 66 transition between potentiometers 10. Additionally, the use of multiple potentiometers 10 may provide redundancy in sensing the location of the upper float 64 and the lower float 66. For example, two potentiometers 10 may be disposed opposite one another along a single length of the column 62, and then two more potentiometers 10 may disposed opposite one another but rotated ninety degrees with respect to the first potentiometers 10 and placed at a different lengthwise position in the column 62. Each pair of potentiometers 10 provides redundant sensing functions for multiple floats, with seamless transition to the next pair of potentiometers 10 which provides redundant sensing functions for multiple floats on the next section of the column 62.

Of course, the column 62 may be modified to other shapes while still providing redundancy in level sensing and/or seamless contiguous sensing at different points along the length of the column 62. For example, the column 62 may be triangular in cross section, and potentiometers 10 may be located on one, two, or all three sides of the triangular column 62. Alternatively, the column 62 may be rectangular, trapezoidal, or any other quadrilateral shape in cross section, and potentiometers 10 may be located on any of one to four sides of the quadrilateral column 62. The column 62 may be pentagonal, hexagonal, or having any number of sides, and potentiometers 10 may be disposed on any available number of sides of the column 62.

As may be appreciated, there may be instances where the levels of two different immiscible liquids of different densities are very similar, such as where there is only a very small quantity of a less dense liquid. In such instances, it may be desirable to utilize a process that still permits detection of the different levels. Thus, the system may be configured to detect even slight differences in the levels of liquids without allowing the upper float 64 and the lower float 66 to interfere with each other. As one example, the floats may be shape so as not to interfere with each other. Thus, the portion of each float configured to float on the desired liquid may be disposed, for example, on opposite sides of the column 62, and the portion of each float configured to magnetically actuate the potentiometer 10 may be disposed upward or downward form that position so the respective floats can measure even very similar absolute liquid levels. The disposition of multiple potentiometers 10 on different sides of the column 62 may also facilitate measurement of fine differences between different liquid levels, as different floats may interact with different potentiometers 10.

In some instances, multiple level measurement assemblies 60 may be disposed within a single container. If, for example, the levels of multiple immiscible liquids are to be measured but the anticipated spacing between levels is such that it may be impractical to provide floats that will not interfere with each other on a single level measurement assembly 60, multiple assemblies 60 may be provided with floats configured for level detection of different liquids. These are just examples of modifications that may be made to the embodiments discussed herein, and are not limiting of the modifications that may be made and embraced by the invention as claimed herein.

There are multiple advantages of the use of embodiments of the level measurement assembly 60. One advantage is the ability to measure the levels of multiple liquids within a container without requiring an ability to visually inspect the container. Indeed, measurement may be made even in containers where it is impractical or impossible to visually inspect the contents thereof, such as pressurized containers, containers housing hazardous materials, and the like. Another advantage is the potential reliability of the system. In embodiments of the level measurement assembly 60, there are no exposed moving and interacting parts or linkages that can become soiled or corroded: the only movement is the sliding movement of the upper float 64 and the lower float 66 along the column 62. The electronic sensing components (the potentiometer(s) 10) are separated from any liquids of the container, and the electrical leads can be similarly protected from exposure to the liquids. As an additional benefit, the liquid level determinations can be made remotely and reliably using simple electrical measurements, even at great distances. Measurements can even be automatically recorded over time, including remotely, using connected electrical or computer systems.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for measuring levels of multiple immiscible liquids of different densities in a container, comprising:
measuring a first electrical signal selected from the group consisting of a resistance, a voltage, and a current between a first terminal and a second terminal of a three-terminal potentiometer, the first electrical signal corresponding to a first location of actuation of the potentiometer; and
measuring a second electrical signal selected from the group consisting of a resistance, a voltage, and a current between the first terminal and a third terminal of the three-terminal potentiometer, the second electrical signal corresponding to a second location of actuation of the potentiometer.

2. A method as recited in claim 1, wherein the potentiometer is disposed in a column in the container containing the immiscible liquids.

3. A method as recited in claim 1, wherein the potentiometer is disposed on a wall of the container containing the immiscible liquids.

4. A method as recited in claim 1, wherein the potentiometer is a magnetically actuated potentiometer.

5. A method as recited in claim 1, wherein the first and second locations of actuation of the potentiometer correspond to locations of first and second floats contained in the container sufficiently proximate the potentiometer to permit magnetic elements of the first and second floats to magnetically actuate the potentiometer.

6. A method as recited in claim 1, wherein the method further comprises measuring changes in the first electrical signal and the second electrical signal.

7. A method as recited in claim 1, wherein the method further comprises translating the first and second electrical signals into measurements of levels of first and second immiscible liquids in the container.

8. A system for measuring levels of multiple immiscible liquids of different densities in a container, comprising:
a vertically disposed three terminal potentiometer capable of magnetic actuation at two locations;
a first float configured to magnetically actuate the potentiometer at a first location; and
a second float configured to magnetically actuate the potentiometer at a second location that differs from the first location.

9. A system as recited in claim 8, wherein the potentiometer is disposed within a column and wherein the first float and the second float are disposed in sliding engagement with the column.

10. A system as recited in claim 9, wherein the column is magnetically inert.

11. A system as recited in claim 9, wherein as a vertical position of the first float on the column and a vertical position of the second float on the column change, the first location of actuation of the potentiometer and the second location of actuation of the potentiometer also change.

12. A system as recited in claim 9, wherein the column contains a plurality of potentiometers, each potentiometer being configured to be magnetically actuated at two locations.

13. A system as recited in claim 8, wherein a first electrical signal corresponding to the first location can be measured between a first terminal of the potentiometer and a second terminal of the potentiometer, and a second electrical signal corresponding to the second location can be measured between the first terminal of the potentiometer and a third terminal of the potentiometer.

14. A system as recited in claim 13, wherein the first and second electrical signals are selected from the group consisting of voltages, currents, and resistances.

15. A system as recited in claim 8, wherein the potentiometer is disposed outside a magnetically inert portion of the outer wall of the container.

16. A system as recited in claim 15, wherein the outer wall of the container adjacent the potentiometer is shaped to retain corresponding portions of the first float and the second float in sliding engagement with the outer wall of the container adjacent the potentiometer.

17. A system as recited in claim 8, wherein the first float and the second float comprise magnets configured to magnetically actuate the potentiometer.

18. A system as recited in claim 8, wherein the first float has a density configured to cause the first float to float at a surface of a first liquid of interest and the second float has a density configured to cause the second float to float at an interface between the first liquid of interest and a second liquid of interest.

19. A system for measuring levels of multiple immiscible liquids of different densities in a container, comprising:
a vertically disposed column contained in a container for multiple immiscible liquids of different densities;
a three terminal potentiometer capable of magnetic actuation at two locations disposed along an inner wall of the column;
a first float in sliding engagement with the column, the first float having a density configured to cause the first float to float at a surface of a first liquid of interest, the first float being configured to magnetically actuate the potentiometer at a first location; and
a second float in sliding engagement with the column below the first float, the second float having a density configured to cause the second float to float at an interface between the first liquid of interest and a second liquid of interest, the second float being configured to magnetically actuate the potentiometer at a second location that differs from the first location.

20. A system as recited in claim 18, wherein the column contains multiple potentiometers each capable of magnetic actuation at two locations through a wall of the column by magnetic elements contained in the first float and the second float.
